(19) United States
(12) Patent Application Publication
(10) Pub. No.: US 2011/0282964 A1
(43) Pub. Date: Nov. 17, 2011

(54) DELIVERY OF TARGETED CONTENT RELATED TO A LEARNED AND PREDICTED FUTURE BEHAVIOR BASED ON SPATIAL, TEMPORAL, AND USER ATTRIBUTES AND BEHAVIORAL CONSTRAINTS

(75) Inventors: Dilip Krishnaswamy, San Diego, CA (US); Robert S. Daley, Del Mar, CA (US); Nakul Verma, San Diego, CA (US)

(73) Assignee: QUALCOMM Incorporated, San Diego, CA (US)

(21) Appl. No.: 12/779,372

(22) Filed: May 13, 2010

(51) Int. Cl. G06F 15/16

(52) U.S. Cl. 709/217

(57) ABSTRACT

Methods and apparatuses and for determining suitability to display information from an information source, such as an advertiser, to a mobile client are described. Learning distribution vectors are tagged to specific content in the information by the advertiser and delivered with the derived learning distribution vectors to the mobile client. The mobile client refines the derived learning distribution vectors based on any one or more combinations of temporal, spatial, attributes, behavioral constraints of the user using context independent/context aware/prediction schemes to determine suitability of the content for display to the user.

### BACKGROUND

This Application incorporates the entire contents of United States non-provisional Patent Application Publication Nos.: 20090125517 entitled “Method and System for Keyword Correlation in a Mobile Environment” (Qualcomm Attorney Docket No. 071913U2) and filed on Nov. 11, 2008; 20090125462 entitled “Method and System using Keyword Vectors and Associated Metrics for Learning and Prediction of User Correlation of Targeted Content Messages in a Mobile Environment” (Qualcomm Attorney Docket No. 071913U5) and filed on Nov. 11, 2008; 20090125321 entitled “Methods and Systems for Determining a Geographic User Profile to Determine Suitability of Targeted Content Messages Based on the Profile” (Qualcomm Attorney Docket No. 072406) and filed on Nov. 14, 2008; 20090124241 entitled “Method and System for User Profile Match Indication in a Mobile Environment” (Qualcomm Attorney Docket No. 071913U1) and filed on Nov. 11, 2008; 20090048977 entitled “User Profile Generation Architecture for Targeted Content Distribution Using External Processes” (Qualcomm Attorney Docket No. 071456U2) and filed on Jun. 6, 2008; 20090013051 entitled “Method for Transfer of Information Related to Targeted Content Messages Through a Proxy Server” (Qualcomm Attorney Docket No. 071456U7) and filed on Jun. 6, 2008; 20090013024 entitled “Methods and Systems for Providing Targeted Information using Identity Masking in a Wireless Communications Device” (Qualcomm Attorney Docket No. 071456U6) and filed Jun. 6, 2008; 20090012861 entitled “Method and System for Providing Targeted Information using Profile Attributes with Variable Confidence Levels in a Mobile Environment” (Qualcomm Attorney Docket No. 071456U4) and filed Jun. 6, 2008; 20090011744 entitled “Method and System for Delivery of Targeted Information Based on a User Profile in a Mobile Communication Device” (Qualcomm Attorney Docket No. 071456U5) and filed Jun. 6, 2008; and 20090011740 entitled “Method and System for Providing Targeted Information based on a User Profile in a Mobile Environment” (Qualcomm Attorney Docket No. 071456U3) and filed Jun. 6, 2008.

### FIELD OF THE DISCLOSURE

This disclosure relates to wireless communications. In particular, the present disclosure relates to wireless communications systems usable for targeted-content-message processing and related transactions.

### BACKGROUND

Various aspects of the subject matter of this application are detailed in the U.S. patent application Publications as incorporated above. However, for the benefit of the reader, a brief summary of some of the underlying issues are reiterated below.

Mobile Targeted-Content-Message (TCM)-enabled systems can be described as systems capable of delivering targeted content information, such as local weather reports and advertisements targeted to a particular demographic, to wireless communication devices (WCDs), such as cellular telephones or other forms of wireless access terminals (W-ATs). Such systems may also provide a better user experience by presenting non-intrusive targeted-content-messages that are likely to be of interest to a user.

An example of a mobile TCM-enabled system is a M-TCM-PS capable of delivering advertisements to wireless communication devices (WCDs). Generally, a M-TCM-PS can provide such things as an advertisement sales conduit for a cellular provider to provide advertisements on a W-AT, as well as some form of analytical interface to report back on the performance of various advertisement campaigns. A particular consumer benefit of mobile advertising is that it can provide alternate/additional revenue models for wireless services so as to allow more economical access to the wireless services to those consumers willing to accept advertisements. For example, the revenue generated through advertising may allow W-AT users to enjoy various services without paying the full subscription price usually associated with such services.

In order to increase the effectiveness of TCMs on W-ATs, it can be beneficial to provide targeted information, i.e., TCMs which are deemed likely to be well received by, and/or of likely interest to, a particular person or a designated group of people.

Targeted-Content-Message (TCM) information can be based on immediate needs or circumstances, such as a need to find emergency roadside service or the need for information about a travel route. Targeted-Content-Message information can also be based on specific products or services (e.g., games) for which a user has demonstrated past interest, and/or based on demographics, for example, a determination of an age and income group likely to be interested in a particular product. Targeted Advertisements are an example of TCMs.

Targeted advertisements can provide a number of advantages (over general advertisements) including: (1) in an economic structure based on cost per view, an advertiser may be able to increase the value of his advertising budget by limiting paid advertising to a smaller set of prospects; and (2) as targeted advertisements are likely to represent areas of interest for a particular user, the likelihood that users will respond positively to targeted advertisements increases substantially.

Unfortunately, the information that makes some forms of targeted advertising possible may be restricted due to government regulations and the desire of people to limit the dissemination of their personal information. For example, in the US, such government restrictions include the Graham-Leach-Bliley Act (GLBA), Title 47 of the United States Code, Section 222—“Privacy of Customer Information.” Common carriers also may be restricted from using personal information about their subscribers for marketing purposes. For example, the GLBA prohibits access to individually identifiable customer information, as well as the disclosure of location information, without the express prior authorization of the customer.

Thus, new technology for delivering targeted content messages and/or information in a wireless communication environment is desirable.

### SUMMARY

In one aspect of various exemplary embodiments disclosed herein, a method for determining relevance of information from an information source to be displayed to a client device is provided, comprising: utilizing at least one or more tagged relative distribution vectors (RDVs) for the information; and learning at least one or more RDVs of a user of the client device based on a user's response to a content of the information

In another aspect, the method described above is provided, wherein the learning is based on an averaging process, or at least one of the tagged RDVs and content of the information is delivered dynamically to the client device.

In another aspect, the initial method described above is provided, further comprising storing the learned RDVs in a user profile on the client device, or matching received information from the information source based on at least one learned RDV in a user profile to determine a suitability of the content of the information for display, or determining to utilize a learned RDV for determining relevance of information based on a convergence of the learned RDV, or utilizing one or more learned RDVs for determining a relevance metric for the information, or displaying content of the information based on a determined relevance of at least one RDV to the user, or storing a determined relevance metric for a later displaying of the content of the information to the user, or storing a determined relevance metric for a later displaying of the content of the information to the user, or refining at least one or more RDV as a function of time, irrespective of any new information, or the determined relevance metric can be used to discriminate against multiple other information to determine to at least one of a most relevant or sorted information, or the additional metrics can be at least one of a keyword correlation metric, energy consumption metric, processing requirement metric, monetary value of the information metric, size of the information metric, duration of information transmission metric, and channel quality metric.

In another aspect, the initial method described above is provided, wherein each of the learned RDV's is accorded a weighting value, or a determined relevance metric is obtained based on a weighted combination over at least one or more RDVs of a distance measure between each tagged RDV in the information and its corresponding learned RDV, or wherein a random RDV is used for determining a relevance metric for the information, or wherein random content is displayed regardless of at least one or more RDVs, or wherein at least one RDV is for a user attribute, or wherein the user attribute is at least one of age, income, gender, and health.

In yet another aspect, the initial method described above is provided, further comprising forwarding at least one or more stored learned RDVs to an anonymizer module for anonymization, or forwarding anonymized information from the anonymizer to a user information gathering module, or at least one tagged RDV from the information source includes statistical information gathered from a population of users, or at least one tagged RDV from the information source includes information that is gathered from an at least one of a survey, explicit user feedback, user behavior, and implicit user feedback.

In another aspect, the initial method described above is provided, wherein at least one RDV is independent across a context of usage of information by the user The method according to claim 1, wherein at least one RDV is determined based on usage of information by the user within in a context, or the context is at least one of music, traffic, purchasing, dining, traveling, browsing, news, weather, sports, and entertainment, or at least one RDV is determined based on usage of information by the user across more than one context, or an overall suitability measure for presentation of content in the information to the user is determined based on the determined relevance metric and zero or more additional metrics, or the tagged RDVs for the information are delivered to the client prior to the delivery of the content of the information, or wherein the content of the information is delivered dynamically to the client device based on the determined suitability measure, or a selection of content for presentation to the user depends on the suitability measure of the content.

In another aspect, the initial method described above is provided, further comprising determining at least one of a future user spatial, temporal and behavioral action based on a predictive user state model, wherein a user state comprises at least one of a user's location, mobility, current time, and behavioral activity, or the predictive state model selects content based on a future predicted state, wherein the prediction of the future state is based on a reduction of an uncertainty of the future state based on at least one or more known prior states, or the predictive state model utilizes the current state and zero or more number of prior states for the prediction of a future state, wherein the choice of the number depends on the amount of increase in the reduction of the uncertainty of the future state based on usage of the knowledge related to the prior states.

In yet another aspect, an apparatus for determining relevance of information from an information source to be displayed to a client device is provided, comprising: means for utilizing at least one or more tagged relative distribution vectors (RDVs) for the information; and means for learning at least one or more RDVs of a user of the client device based on a user's response to a content of the information.

In yet another aspect an apparatus for determining relevance of information from an information source to be displayed to a client device is provided, comprising: a processor linked to the memory and configure to control operations for: utilizing at least one or more tagged relative distribution vectors (RDVs) for the information; learning at least one or more RDVs of a user of the client device based on a user's response to a content of the information; and a memory coupled to the processor for storing data.

In yet another aspect a computer program product is provided, comprising: a computer-readable medium comprising: code for utilizing at least one or more tagged relative distribution vectors (RDVs) for the information; and code for learning at least one or more RDVs of a user of the client device based on a user's response to a content of the information.

### BRIEF DESCRIPTION OF THE DRAWINGS

The features and nature of the present disclosure will become more apparent from the detailed description set forth below when taken in conjunction with the drawings in which reference characters identify corresponding items and processes throughout.

FIG. 1 is a diagram showing the interaction between an exemplary wireless access terminal (W-AT) and an advertising infrastructure.

FIG. 2 is a block diagram showing an exemplary operation of a data transfer of a user profile generation agent.

FIG. 3 is a block diagram handling an exemplary request for profile data processing.

FIG. 4 is a flow chart of an exemplary keyword correlation process.

FIG. 5 is a block diagram of an exemplary learning engine/prediction engine model.

FIG. 6 is an illustration of an exemplary sample ad-server architecture.

FIG. 7 is an block diagram of an exemplary context independent/context aware model.

FIG. 8 is block diagram of an exemplary context independent flow path.

FIG. 9 is a graphical illustration of an RDV.

FIG. 10 illustrates an example of relationship vectors between arbitrary states.

FIG. 11 provides an exemplary flow path for implementing learning distribution vectors.

### DETAILED DESCRIPTION

The disclosed methods and systems below may be described generally, as well as in terms of specific examples and/or specific embodiments. For instances where references are made to detailed examples and/or embodiments, it should be appreciated that any of the underlying principals described are not to be limited to a single embodiment, but may be expanded for use with any of the other methods and systems described herein as will be understood by one of ordinary skill in the art unless otherwise stated specifically.

For the purpose of example, the present disclosure is often depicted as being implemented in (or used with) a cellular telephone. However, it is to be appreciated that the methods and systems disclosed below may relate to both mobile and non-mobile systems including mobile phones, PDAs and lap-top PCs, as well as any number of specially equipped/modified music players (e.g., a modified Apple iPOD®), video players, multimedia players, televisions (both stationary, portable and/or installed in a vehicle), electronic game systems, digital cameras and video camcorders.

The terms and respective definitions/descriptions below are provided as a reference to the following disclosure. Note, however, that when applied to certain embodiments, some of the applied definitions/descriptions may be expanded or may otherwise differ with some of the specific language provided below as may be apparent to one of ordinary skill and in light of the particular circumstances.

TCM—Targeted-Content-Message. An advertisement can be an example of a Targeted-Content-Message.

M-TCM-PS—Mobile Targeted-Content-Message Processing System

MAS—Mobile advertising system, which may be considered a form of M-TCM-PS.

UPG—User Profile Generation Agent

M-TCM—Mobile TCM-Enabled Client

MAEC—Mobile advertising enabled client. This can be an example of a Mobile TCM-Enabled Client

Mobile TCM Provider (M-TCM-P)—A person or an entity that may want to display a targeted-content-message through a targeted-content-message processing system.

Advertiser—A person or an entity that may want to display advertisements through a mobile advertising system (MAS). An advertiser may provide the advertisement data along with respective targeting and playback rules, which may in some instances form advertisement metadata to a MAS. An advertiser is an example of a Mobile TCM Provider.

TCM Metadata—A term used to identify data that can be used to provide additional information about a respective Targeted-Content-Message (TCM).

Advertisement Metadata—A term used to identify data that may be used to provide additional information about a respective advertisement. This may include, but is not limited to, mime type, advertisement duration, advertisement viewing start time, advertisement viewing end time, etc. Respective advertisement targeting and playback rules provided by the advertiser may also get attached to an advertisement as metadata for the advertisement. Advertisement Metadata is an example of TCM metadata.

Application Developer—A person who or an entity that develops an application for the mobile advertising enabled client (MAEC) that can feature advertisements.

System Operator—A person who or entity that operates a MAS.

Third Party Inference Rule Provider—A third party (other than a system operator) who may provide user profile inference rules to be used by a User Profile Generation Agent

User Profile Generation Agent—A functional unit at the client that may receive various pertinent data, such as advertisement inference rules, user behavior from a metric collection agent, location data from a GPS, explicit user preferences entered by a user (if any) and/or user behavior from other client applications, then generate various user profile elements. A User Profile Generation Agent may continuously update a profile based upon information gathered that may be used to characterize user behavior.

User Behavior Synthesizer—A functional device or agent within a User Profile Generation Agent that may be used to receive a variety of data, such as user behavior information, location information and user profile inference rules to generate synthesized profile attributes.

Profile Element Refiner—A functional device or agent within a User Profile Generation Agent that may receive profile attributes generated by a user behavior synthesizer as well as a number of user profile inference rules. A Profile Element Refiner may refine profile attributes, process them through queries sent to a profile attribute processor, and generate user profile elements.

Profile Attribute Processor—A server and/or resident agent of a server that may process profile attribute requests that may require data-intensive lookups, and then respond with refined profile attributes.

TCM Filtering Agent—A client agent that may receive a number of TCMs with their respective meta-data, TCM targeting rules and TCM filtering rules, then store some or all of the TCMs in a TCM-cache memory. The filtering agent may also take a user profile as input from the User Profile Generation Agent.

Advertisement Filtering Agent—A client agent that may receive a number of advertisements with their respective metadata, advertisement targeting rules and advertisement filter rules, then store some or all of the received advertisements in an advertisement cache memory. The filtering agent may also take a user profile as input from the User Profile Generation Agent. An advertising filtering agent is an example of a TCM filtering agent.

TCM Cache Manager—A client agent that can maintain a targeted content-message cache. A cache manager may take cached targeted content-messages from a filtering agent, and respond to content-message requests from other applications on the access terminal. Note that, for the present disclosure, the term ‘cache’ can refer to a very broad set of memory configurations, include a single storage device, a set of distributed storage devices (local and/or not local) and so on. Generally, it should be appreciated that the term ‘cache’ can refer to any memory usable to speed up information display, processing or data transfer.

Advertisement Cache Manager—A client agent that can maintain an advertisement cache. A cache manager may take cached advertisements from a filtering agent and respond to advertisement requests from other applications on the access terminal. An advertisement cache manager is an example of a TCM cache manager.

User Profile Attributes—User behavior, interests, demographic information, and so on that may be synthesized by a user behavior synthesizer to form profile attributes, which may be viewed as intermediate pre-synthesized forms of data that may be further processed and refined by a profile element refiner into more refined user profile elements.

User Profile Elements—Items of information used to maintain a user profile, which may include various types of data useful to categorize or define the user's interests, behavior, demographic, etc.

TCM Targeting Rules—These may include rules related to the presentation of a targeted-content-message specified by a Mobile TCM Provider.

Advertisement Targeting Rules—These may include rules specified by advertisers to impose rules/restrictions on how advertisements may be displayed and/or rules to target an advertisement towards a particular segment of users. They may be specific to a number of criteria, such as an advertisement campaign or advertisement group. Advertisement Targeting Rules are an example of TCM Targeting Rules.

TCM Playback Rules—These can include display rules specified by a client application while querying a TCM Cache Manager for TCMs to display in the context of their application.

Advertisement Playback Rules—These can include display rules specified by a client application while querying an Advertisement Cache Manager for advertisements to display in the context of their application. Advertisement Playback Rules are an example of TCM Playback Rules.

TCM Filter Rules—These can include rules upon which TCMs may be filtered. Typically, a system operator may specify these rules.

Advertisement Filter Rules—These can include rules upon which advertisements may be filtered. Typically, a system operator may specify these rules. Advertisement Filter Rules are an example of TCM-Filter-Rules.

User Profile Element Inference Rules—These can include rules, specified by a system operator (and/or a third party), that may be used to determine one or more processes usable to build a user profile from demographic and behavioral data.

TCM Telescoping—A display or presentation function for a TCM whereby additional presentation material may presented to a user in response to a user request.

Advertisement Telescoping—An advertisement display or presentation function whereby additional presentation material may be presented to a user in response to a user request. Advertisement Telescoping is an example of TCM telescoping.

As mentioned above, various regulations regarding telecommunications and privacy can make the delivery of messages with targeted content difficult. However, the present disclosure can provide a variety of solutions to deliver targeted content to wireless access terminals (W-ATs), e.g., cellular phones, while paying attention to privacy concerns.

One of the many approaches of this disclosure used to alleviate privacy issues includes offloading a variety of processes onto a user's W-AT that may, in turn, be used to generate a set of information that likely characterizes the user, i.e., it can create a “user profile” of the user on the W-AT itself. Accordingly, targeted-content-messages, such as advertisements and other media, may be directed to the user's W-AT based on the user's profiles without exposing potentially sensitive customer information to the outside world.

The various disclosed methods and systems may be used in a Mobile TCM Processing System (M-TCM-PS) (and, in particular, in a Mobile Advertising System (MAS)), which for the present disclosure may include an end-to-end communication system usable to deliver targeted-content-messages (or in particular, advertisements) to TCM-Enabled W-ATs (or in particular Mobile Advertising Enabled W-ATs). A M-TCM-PS may also provide an analytical interface capable of reporting on the performance of a particular advertisement campaign. Accordingly, an appropriately constructed M-TCM-PS may provide a better consumer experience by presenting only non-intrusive advertisements that are likely to be of interest to consumers.

While the following examples are generally directed to content, such as commercial advertising, a broader scope of directed content is envisioned. For example, instead of directed advertisements, content such as stock reports, weather reports, religious information, news and sports information specific to a user's interests, and so on is envisioned within the bounds of this disclosure. For example, while directed content may be an advertisement, a score for a sports event and a weather report may just as easily be directed content. Accordingly, devices such as advertising servers may be viewed as more general content servers, and advertising-related agents and devices may be more generally thought of as content-related agents and servers. All further discussion is provided in the context of advertisements as an example of a TCM (Targeted Content Message), and it should be noted that such discussion is applicable to Targeted-Content-Messages in general.

Introduction

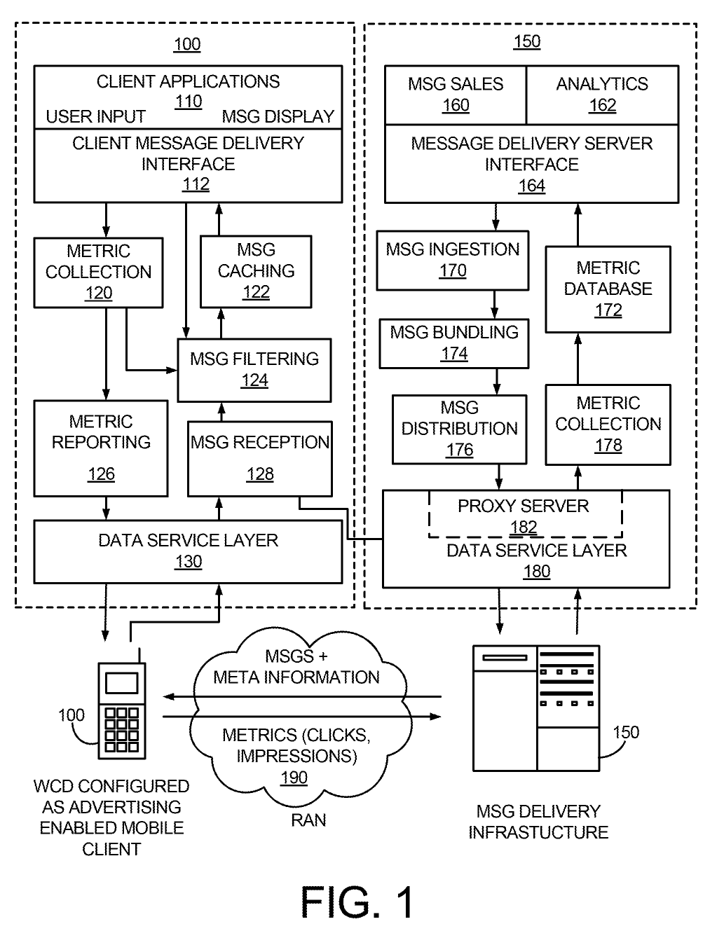

FIG. 1 is a diagram of some of the various functional elements of an M-TCM-PS showing the interaction between a TCM-enabled W-AT 100 with a communication network having an advertising infrastructure. As shown in FIG. 1, the exemplary M-TCM-PS includes the TCM-enabled mobile client/W-AT 100, a radio-enabled network (RAN) 190 and an advertising infrastructure 150 embedded in the network associated with the wireless WAN infrastructure (not shown in FIG. 1). For example, the messaging infrastructure could be available at a remote server not geographically co-located with a cellular base station in the wireless WAN.

As shown in FIG. 1, the W-AT can include a client applications device 110, a client message delivery interface 112, a metric collection agent 120, a message caching manager 122, a message filtering agent 124, a metric reporting agent 126, a message reception agent 128 and a data service layer device 130. The message delivery infrastructure 150 can include a TCM sales agent 160, an analytics agent 162, a message delivery server interface 164, a message ingestion agent 170, a message bundling agent 174, a message distribution agent 176, a metric database 172, a metric collection agent 178, and having a proxy server 182.

In operation, the “client side” of the M-TCM-PS can be handled by the W-AT 100 (depicted on the left-hand side of FIG. 1). In addition to traditional applications associated with W-ATs, the present W-AT 100 may have TCM-related applications at the applications level 110, which in turn may be linked to the rest of the M-TCM-PS via a client advertisement interface 112. In various embodiments, the client message delivery interface 112 may provide for metrics/data collection and management. Some of the collected metrics/data may be transferred to the metric reporting agent 126 and/or to the W-AT's data service layer 130 (via the metric collection agent 120), without exposing individually identifiable customer information, for further distribution to the rest of the M-TCM-PS.

The transferred metrics/data may be provided through the RAN 190 to the message delivery infrastructure 150 (depicted on the right-hand side of FIG. 1), which for the present example includes a variety of TCM-related and privacy-protecting servers. The message delivery infrastructure 150 can receive the metrics/data at a data service layer 180, which in turn may communicate the received metrics/data to a number of metrics/data collection servers (here metric collection agent 178) and/or software modules. The metrics/data may be stored in the metric database 172, and provided to the message delivery server interface 164 where the stored metrics/data may be used for marketing purposes, e.g., advertising, sales and analytics. Note that information of interest may include, among other things, user selections at a W-AT and requests for advertisements executed by the W-AT in response to instructions provided by the message delivery infrastructure 150.

The message delivery server interface 164 can provide a conduit for supplying advertisements (advertising ingestion), bundling advertisements, determining a distribution of advertisements and sending advertising through the data service layer 180 of the message delivery infrastructure 150 to the rest of the M-TCM-PS network. The message delivery infrastructure 150 can provide the W-AT 100 with the appropriate TCMs, and metadata for the TCMs. The W-AT 100 can be instructed by the message delivery infrastructure 150 to select TCMs based on any available metadata according to rules provided by the message infrastructure 150.

As mentioned above, the exemplary W-AT 100 may be enabled to generate, in whole or in part, a user profile for the W-AT's user that, in turn, may be useful to enable the M-TCM-PS to deliver TCMs of likely interest to the user. This may result in better “click-through rates” for various advertisement campaigns and other TCM delivery campaigns. However, as mentioned above, generating a user profile may raise privacy concerns because of the potentially sensitive nature of data that may reside in the user profile.

Nevertheless, the various device and system embodiments, privacy concerns may be alleviated by enabling a user's W-AT to generate a user profile while subsequently limiting the user profile to the confines of the user's W-AT except in very limited (and controlled) circumstances.

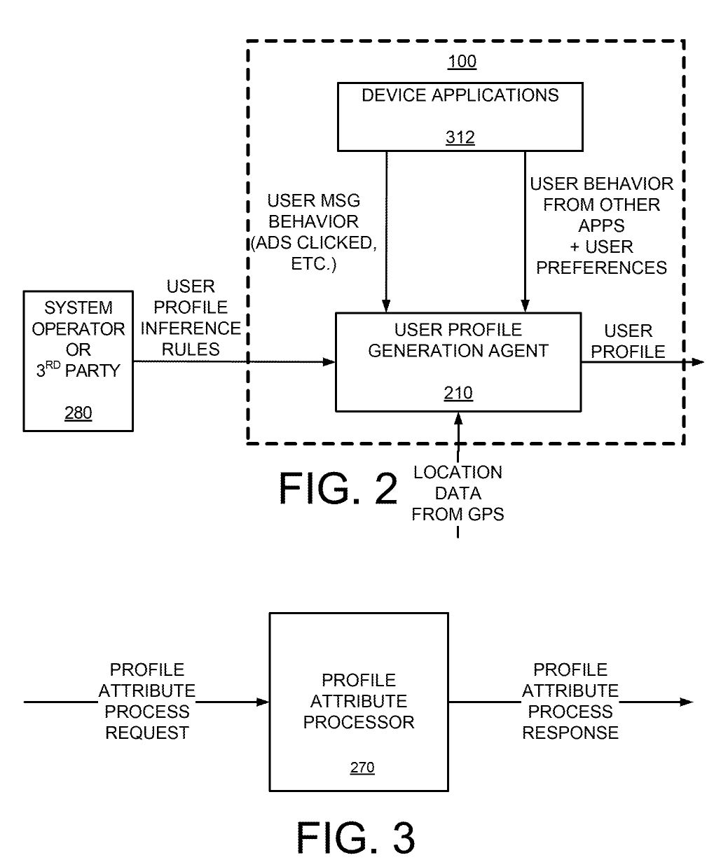

FIG. 2 is a schematic block diagram of the previously presented user profile generation agent 210 shown in the context of interacting with other devices 312 and 280. Various capabilities of the user profile generation agent 210 are provided in part below.

One of the features of a mobile phone is that it can be carried by a user wherever he/she goes. Utilizing the GPS capabilities of a W-AT, the W-AT can determine where the user is periodically or a-periodically spending some or most of his/her time. As there is often demographic data associated with locations, the use of GPS information and demographic data associated with locations that the user frequents may allow the development of at least some portions of a demographic profile associated with the user. Typical demographic profile elements associated with the user's profile using the location information may include, but are not limited to:

Location ZIP code

Gender

Median age for the frequented location

Age distribution and associated probability

Mean travel time to work

Household income or household income range

Household size

Family income or family income range

Family size

Marital status

Probability of owning a house

Probability of renting a house

Life-stage group/classification

Note that multiple demographic user profiles can be maintained at the W-AT for the user. For example, an M-TCM Enabled Client might be configured by the network to maintain two demographic profiles for the user—one for his “home” location (most frequented location between, say, 21:00-06:00) and one for his “work” location (most frequented location between, say 09:00-17:00).

In addition to general demographics, a user profile may be further developed using any of a W-AT's numerous applications. Which applications, e.g., games, a user tends to spend most of his time with or how he interacts with the various applications on the phone may provide an opportunity to build a profile for the user based on his behavior and preferences. Most of the data mining and user behavior profile determination of this sort can be done on the W-AT itself, being driven by user profile inference rules fed to the user profile generation agent 210. Typical behavioral profile elements associated with a user may include, but are not limited to, the following:

Application ID and time spent in the application

Interest categorization

Favorite keywords

Favorite websites

Advertisements of interest

Music album

Games of interest

Many profile elements (including demographics) can be inferred from behavior mined by adding hooks to observe application behavior through a native user interface application on a W-AT. It is through such applications that the user may launch other applications. Applications of interest to the user and time spent in these applications can be inferred by monitoring when the user launches and exits a particular application.

Rules fed to the user profile generation agent 210 can associate interest categories for a user based on the user's interactions with applications. Interest categories can also be assigned to the user profile using server assisted collaborative filtering on the behavior data collected at the W-AT.

Rules that may get downloaded to the user profile generation agent 210 may allow a server to control the functioning of the user profile generation agent 210 in a dynamic fashion. By mining raw data on the incumbent W-AT and synthesizing it into more meaningful information (profile attributes), particular sensitive user behavior information can be transformed into advertisement behavior categories and user profile elements versus maintaining data in raw form.

An exemplary W-AT can keep track of the messages of interest to the user and the keywords associated with such messages. For example, multiple clicks on the same advertisement may indicate to a user profile agent an interest level associated with the associated keywords and advertisement. On the same lines, games and music of interest to the user can be maintained at the W-AT. Server-assisted mode can also be used to associate user interest categories with the user's profile based on the user's music and game play-lists.

As a user profile is developed and maintained, such a profile can take a variety of forms, e.g., synthesized profile attributes and elements.

Note that some or all data attributes and elements in a user profile may have some confidence level associated with them. That is, because certain elements and attributes are based upon inferences and rules, their results may not be certain and have “fuzziness” associated with them. This fuzziness may be expressed as a confidence level associated with a user profile attribute and element.

By way of example, noting that a user is sending more that five-hundred SMS messages per month, the profile generator might say that the user is likely to be in the age group from 15-24 with a confidence level of 60%. That means that if 100 users sending more than five-hundred SMS messages per month were to be polled for their age, about 60 of them are likely to fall within the age group of 15-24.

Similarly, when a demographic profile is inferred for a user based on his/her home location, there may be a confidence level associated with the profile attributes. The confidence level here may indicate the number of times the profile attribute is expected to be accurate in a sample of one-hundred users with the same home location.

The exemplary user profile generation agent 210 can also be fed rules to combine confidence levels on the same profile attribute from multiple sources to come up with a unified confidence level for the attribute. For example, if the SMS usage rate indicates that the user is within the age group of 15-24 years with a 60% confidence level and demographic profile for the home location indicates that the user is in age group of 15-24 years with a 20% confidence level, then these two items can be combined with, for example, fuzzy logic rules to come up with a unified confidence level for the user lying in the same age group.

In contrast, if a user enters his interest preferences into the client, then such values might be given a confidence level of close to 100% since they are coming directly from the user. Similarly if the carrier specifies any user profile attributes/elements based on the user data it has (billing data or optional profile data collected from the user during service sign-up), then that too will have a higher confidence level associated with it.

As more user behavior data is collected on a W-AT and inferences made based on that, subsequent confidence level, in the profile attribute and element values, is expected to increase.

FIG. 3 is a schematic block diagram for a profile attribute processor 270 handling a request by a W-AT for profile attribute processing. As discussed above, while a W-AT may be able to handle most processing, there may be cases where huge database lookups are required to determine portions of a behavior or demographic profile. An example of such cases includes instances where census databases, which may require gigabytes of storage, are useful. Accordingly, a profile attribute processor (or other assisting server) may be used to process user information to provide more refined forms of user profile information.

Before a request is received by a profile attribute processor 270, synthesized profile attributes may be gathered at the relevant W-AT, and sent to the profile attribute processor 270 noting that the use of synthesized profile attributes can result in better use of bandwidth. Some of the user profile attributes, which require data-intensive lookups, can be processed by the profile attribute processor 270 optionally by anonymously querying techniques to protect user identities. The profile attribute processor 270 may further refine any received attributes, and provide the refined data to the appropriate W-AT in what may be referred to as a set of refined user profile attributes.

When activated by a request from a W-AT, the profile attribute processor 270 may process various types of specific and non-specific synthesized data regarding a user's behavior and demographics (e.g., profile attributes) and respond with the appropriate refined profile information. In order to maintain user privacy, some form of data scrambling, e.g., a hashing function and a number of other tools may be employed via a device, such as the one-way hash function generator. In operation, it is possible to use a hash function at a W-AT to hide the user's identity from the rest of the M-TCM-PS network.

In various operations, a hashing function employed in a W-AT can generate a predictable and unique, but anonymous, value associated with a particular user. Such an approach can enable the W-AT to query external servers without compromising on the privacy of the user. In various embodiments, a hashing function may be based on a primary identifier of the W-AT, e.g. a serial number associated with the W-AT, as well as a random value, a pseudo-random value, and a time-based value. Further, the hashing function may be calculated to provide a low probability of collision with other generated values.

The W-AT may use the same random number for subsequent queries to allow external servers to associate multiple queries from the same client. The use of the random number can help to prevent external servers (or unauthorized agents) from doing a reverse lookup on a subscriber base to determine a user's identity.

Once a hashed value is generated, the hashed value may be used as an alternate user identifier for the W-AT and provided, along with geographic information or some or items of information from a user profile to a remote apparatus.

Subsequently, one or more targeted content messages can be received from the remote apparatus based on the alternate user identifier and first advertisement-related information to the remote apparatus and/or other information capable of supplementing a user profile. Such information can be incorporated into the user profile of the W-AT.

One of the potential inputs in a match indicator calculation described above may be a correlation value derived between the previous messages viewed, i.e. a “viewing history” of the user and new messages. In this context, messages may be associated with keywords from a dictionary at the advertisement sales interface, according to design preference.

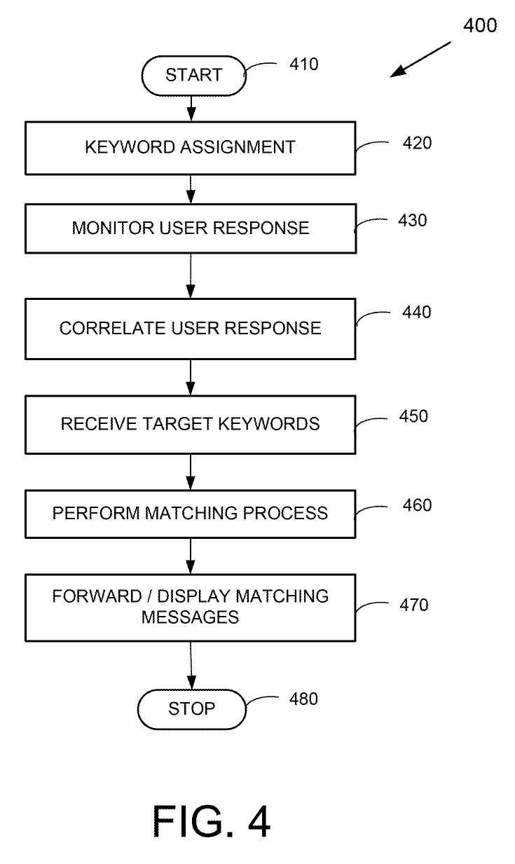

Referring now to FIG. 4, a process 400 is described that includes an exemplary generation and use of keyword associated message delivery. The process starts in step 410 and continues to step 420 where keywords can be assigned to various messages. For example, an advertisement directed to women's apparel may have four keywords including “fashion”, “female”, “clothing” and “expensive”. The keyword(s) may be broadly associated with a genre of advertisements/messages or may be individually associated with a particular species of advertisement(s)/message(s). Thus, depending on the level of resolution or discrimination desired, more than one keyword may be associated with a particular advertisement/message or vice versus. In various embodiments, keywords may be limited to an advertisement/message dictionary or index.

Continuing, such keywords can be given weights (e.g., a number between 0 and 1) to help describe the strength of association between a particular message and the meaning of the keyword. If keywords are determined to not have an associated or impressed weight, their weights can be assumed to be 1/n where n is the total number of keywords associated with a message. In this manner, a gross averaging weight can be applied by the 1/n factor, in some sense to normalize the overall keyword values to within a desired range.

Assigned weights can provide some degree of normalization, especially in the context of multiple keywords (for example, 1/n, given n keywords, with each keyword having a maximum value of 1), or can be used to “value” the keyword or the advertisement/message/TCM according a predetermined threshold or estimation. For example, some keywords may have a higher or lower relevance depending on current events or some other factor. Thus, emphasis or de-emphasis can be imposed on these particular keywords via the weighting, as deemed appropriate. Step 420 is presumed to have the measure of assigning a weight to the keyword as part of the keyword association for a fixed keyword value estimation. However, in some instances a weight may not have been pre-assigned or the weight valuation is undetermined. In those instances, an arbitrary value can be assigned to the keyword, for example, a weight of 1. It is presumed that these keywords are forwarded to a mobile client. Control continues to step 430.

In step 430, user response to messages may be monitored. In operation, messages can be presented to users whereupon the users may choose to “click” on them or not. As should be apparent in this technology, the term “click” can be assumed to mean any form of user response to the presence of the message or as part of an operational message sequence. In some user embodiments, a lack of response may be construed as an affirmative non-click or click-away response, analogous in some contexts to a de-selection. Thus, a mobile client user's response to various advertisements/messages/TCMs can be historically gauged.

By monitoring the user's “click” response in relation to a general population or even a targeted population of advertisements/messages/TCMs, an initial assessment of the user's interests can be obtained.

In various embodiments, a user's response time for a given advertisement/message or a series of advertisements/messagesTCMs can also be used to gauge the user's interest therein. For example, a user may click through several advertisements/messages/TCMs, each having different degrees of relevance or keywords, and the rate of click through or tunneling can be understood to be indicative of user interest. Control continues to step 440.

In step 440, a comparison of the user selection (for example, click) of a particular advertisement/message and its corresponding keyword(s) can be performed to establish at least a “baseline” correlation metric. Again, it may be noted that the selection of and/or rate of selection can be used in determining the user's interest in a keyword-associated advertisement/message/TCM. By this comparison, a correlation between the various keyword and the user's advertisement/message/TCM preference may be provided. This correlation can be accomplished using any one of several methods, such as, for example, statistical methods, fuzzy logic, neural techniques, vector mapping, principal components analysis, and so forth. From step 440, a correlation metric of the user's response to an advertisement/message/TCM can be generated.

In various exemplary embodiments, a “keyword correlation engine” embedded on a message delivery system and/or W-AT may track the total number of times a particular message/advertisement/TCM may presented (or forwarded) to a user with a particular keyword (for example, N_total-keyword) along with the total number of clicks for that keyword (for example, N_click-keyword). The ratio of N_click-keyword/N_total-keyword may be computed to determine the correlation of the keyword to the user's response. The weight for a keyword for a message may be assumed to be 1 if the keyword is specified without an associated weight for a given message. By formulating a ratio as described above, a metric for gauging the reaction or interest of the user to a keyword tagged advertisement (or TCM) can be generated, and refinements or improvements to the match can be devised accordingly. In the above example, affirmative clicks can be used to indicate a user's interest. However, again it should also be appreciated that in some embodiments, a non-click or lack of direct response also may be used to infer an interest level or match relevance.

As an illustration of one exemplary implementation, assume that there are N keywords for a given TCM/advertisement(s). An N-dimensional vector A can be created based on the associated keyword weights. An N-dimensional correlation vector B can be created with the correlation measure of each keyword for the advertisement(s) to the user in each dimension. A scalar correlation measure C, to establish the correlation of the advertisement to the user, can then be created which is a function of the vectors A and B. The correlation measure C may be, in some embodiments, simply a dot product of the vectors A and B (C=A·B as C=(1/N) A·B). This scalar correlation measure C offers a very simple and direct measure of how well the advertisement is targeted to the specific user based on his previous advertisement viewing history. Of course, other methods may be used to correlate the A-to-B correspondence, such as parameterization, non-scalar transformations, and so forth.

The above approach assumes that the keyword dictionary has keywords that are independent of each other. Should the keywords be inter-related, fuzzy logic can be used to come up with a combined weight for the set of inter-related keywords. Other forms of logic or correlation can be implemented, such as polynomial fitting, vector space analysis, principal components analysis, statistical matching, artificial neural nets, and so forth. Therefore, the exemplary embodiments described herein may use any form of matching or keyword-to-user correlation algorithm as deemed necessary. Control continues to step 550.

In step 450, the mobile client or user may receive “target keyword(s)” associated with various prospective targeted messages/advertisements/TCMs. Next, in step 460, the received target keyword(s) may be evaluated to determine if there is a match or if the keyword(s) meet an acceptable threshold. In various embodiments, a matching evaluation can involve higher algorithms, such as statistical methods, fuzzy logic, neural techniques, vector mapping, principal components analysis, and so forth, if so desired. It should be appreciated that the correlation process of step 440 and the matching process of step 460 may be complementary. That is, different algorithms may be used with the respect processes, depending on design preference or depending on the type of advertisement/message/TCM keyword forwarded. Control continues to step 470.

In step 470, those targeted “messages” deemed to match within a threshold of acceptance may be forward and/or displayed to the user. The forwarding of the advertisement/message/TCM may take any one of several forms, one such form, for example, being simply permitting the matching advertisement/message/TCM to be received and viewed by the user's device. In some embodiments, a non-match advertisement/message/TCM may be forwarded to the user, but is disabled so as to prevent instantiation or viewing. Thus, in the event that the user's preferences or profile is subsequently modified, a prior non-acceptable advertisement/message/TCM but now acceptable advertisement/message/TCM may be resident on the user's device and appropriately viewed. Of course, other schemes for making available advertisements/messages/TCM that are deemed to be “matching” or “non-matching” may be devised without departing from the spirit and scope of this invention. After step 470, the exemplary process 400 proceeds to step 480 where the process is terminated.

By use of the above exemplary process 400, targeted advertising/messages/TCMs can be filtered to be apropos to the user's interests. The user's interests can be initially established by historically monitoring the user's “click” response on the user's mobile client against a set of advertisements/messages/TCMs via keyword assignment and matching. Dynamic monitoring can then also be accomplished by updating the user's interest profile, based on currently observed user response(s). Accordingly, a more direct or more efficient dissemination of targeted advertisements/messages/TCMs can be obtained, resulting in a more satisfying mobile client experience.

Learning and Prediction Engine

It is understood that a significant amount of information can flow through a mobile device associated with a user during the lifetime of the device. The user may interact with some fraction of the information that is presented to it. Due to memory constraints, it would be impossible to store all such information on the mobile device itself, much less all the meta-data and the user responses. An efficient approach is to utilize a learning engine that captures user preferences and presented information and, ideally, to have in part a prediction engine based on the learned model, to suggest the likelihood of user interest for new information that is presented to the user. New content as it arrives on the mobile device could be accordingly filtered, so that relevant information can be presented to the user. The learning and/or prediction engines could utilize meta-data as well as any user responses associated with presented information, whether keyword dependent or not.

For example, information that is not keyword dependent, such as location, age, demographics, movement pattern, personal behavior, and so forth can be considered as information that can be utilized for better targeting of messages. Also, the various metrics for use by the exemplary embodiments may be pre-configured (e.g., default/initial setting) or may be developed as the user or environment evolves.

The predicted future behavior could depend on a locational feature or trend, such as the physical route or a set of physical routes that the user may take in the future. Targeted content messages can be selected by matching the applicability of the targeted content message at a specific location and time along the route(s) associated with the user, and matching the message in concert with an available user profile.

Another example of an available user profile may be the age, as directly obtained or indirectly inferred by the behavior/response patterns of the user. Since such a profile may require a period of learning to correctly develop a prediction of the age or age range of the user, mechanisms for learning or associating the behavior/response patterns that are well known can be applied. For example, statistical or relational approaches are understood to be well suited for learning or developing associations

In view of the above, a predictive model can be created for user travel behavior based on past observations of user location as a function of time, for example. The predictive model can have the ability to suggest the possible routes that the user may take at a given time of the day, where the routes may be associated with different probabilities. The most likely routes can be chosen for a given time or interval of time or series of events encountered by the user (e.g., traffic jam and ensuing rerouting). Also, varying probabilities can be assessed on either one or a set of routes deemed likely. An example of an entropy based approach is described below. Of course, other methods, too numerous to mention, that are well known in the art may be used without departing from the spirit and scope herein.

Based on the predictions, a set of possible targeted content messages are selected from a pool of available such messages that relate to the routes chosen for that time or interval of time, and also based on an available user behavioral profile (age being one non-limiting example), to create a set of matched targeted content messages. The set of matched targeted content messages are delivered to a mobile device (one non-limiting example would be a phone) or in general a mobile entity (such as car, for example) of the user. The messages and/or meta-data associated with the messages could be stored in an information storage space on the mobile device/entity belonging to the user. The messages may also be stored in a distributed manner such that the meta-data associated with the information is stored on the mobile device/entity while the detailed message information is stored remotely on a server. The targeted content message information may be presented to the user at any time prior to the expected time of usefulness of the information to the user. Based on additional spatial, temporal, and user behavioral observational information, and constraints associated with the mobile device/entity, the selected list of targeted content messages can be adaptively pruned or modified. Further, a dynamic delivery of the content or other information relating to the content (including relative distribution vectors, as discussed below) can be delivered to the user.

Also, rather than waiting for a user to arrive at a predicted location, a set of possible relevant messages can be determined well in advance of the user arriving at that location and time. Different messages can be determined for different plausible location and time values for the user. The user may choose a specific route among a set of possible routes based on the presented information. The user may also be able to take advantage of the targeted content message, if beneficial to the user, when the user gets closer to a specific location and time. Consequently, once the behavioral pattern of the user is learned, messages can be forwarded that may actually induce the user to change his path, and expose the user to other options not within the norm of the user's pattern. For example, the user may be en route to work, and a famous brand coffee shop may be nearby, though not necessarily en route. A message may be sent to the user offering a coupon for the famous brand coffee shop, enticing the user to re-route himself to take advantage of the coupon.

In another scenario, the profile/behavioral prediction engine for the user may be refined to predict not only the age range of the user but also a birthday or an anniversary that is important to the user. When that date draws near, the messages forwarded to the user may be appropriately tailored. As one example, for established, older users, they would likely consider a vacation as a good expression to celebrate their birthday. Accordingly, travel specials would be a good message/advertisement/TCM for this user. For younger, high school or college age users, a gift coupon or less extravagant message/advertisement/TCM would be more effective.

Also, with respect to location prediction, rather than generating one particular message type or genre to be forwarded to the user, the prediction engine could generate a “set” of suitable messages/TCMs/etc. that would be highly appropriate for a given set of possible locations with the understanding of minimizing messages that may be irrelevant due to the user being at a location that is not correctly predicted. Conversely, the prediction engine could generate a different set of suitable messages/TCMs/etc., based on a higher probability or indication that the user is at a particular location or a particular set of locations (that is, trading off relevance of messages with accuracy of location).

Another way of expressing in part, the above described approach is to target messages related to a predicted future behavior based on spatial, temporal, user behavioral constraints, etc., all of which may be adjusted as with the user's interaction as measured by the distribution vectors that track the user's behavior, etc.

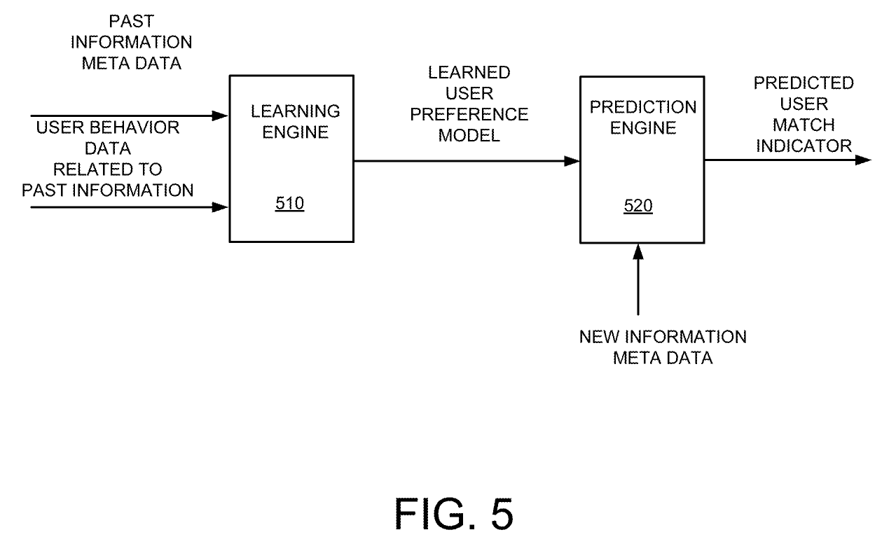

FIG. 5 is a block diagram showing some forms of information that may be used for the learning engine 510 which uses past information meta-data and user behavior related to the respective past information. Based on the input, the learning engine 510 refines and outputs a learned user preference model. This user preference model is used as an input to prediction engine 520 which also receives information, including meta-data, related to new information, and correlates the meta-data/information with the learned user preference model, to output a predicted user match indicator for the new information. This user match indicator can then be used as a factor in determining whether or not the information is presented to the user.

Information Processing Architecture

In view of the above, the architecture and algorithms to efficiently model a user's profile from their interactions with the mobile device are described. These interactions can range from response to targeted-content-messages (such as advertisements) that are presented to the user to launching the music player to play specific songs, and so forth. An effective solution would be a solution that is fast and does not scale with amount of data measured. The presented architecture and algorithms can be applied to different contexts without loss of generality. Additionally, based on the model that is learned by the system, when new information arrives at the mobile device, a prediction engine can present a match indicator for the ad/information relative to the learned preferences of a given user. This match indicator can be used along with other system constraints (such as revenue or size information, for example) to take a decision on whether to present the ad/information real-time to the user, or to take a decision on whether to store the information on the user's mobile device such as in a space-constrained targeted-content-message cache on the mobile device.

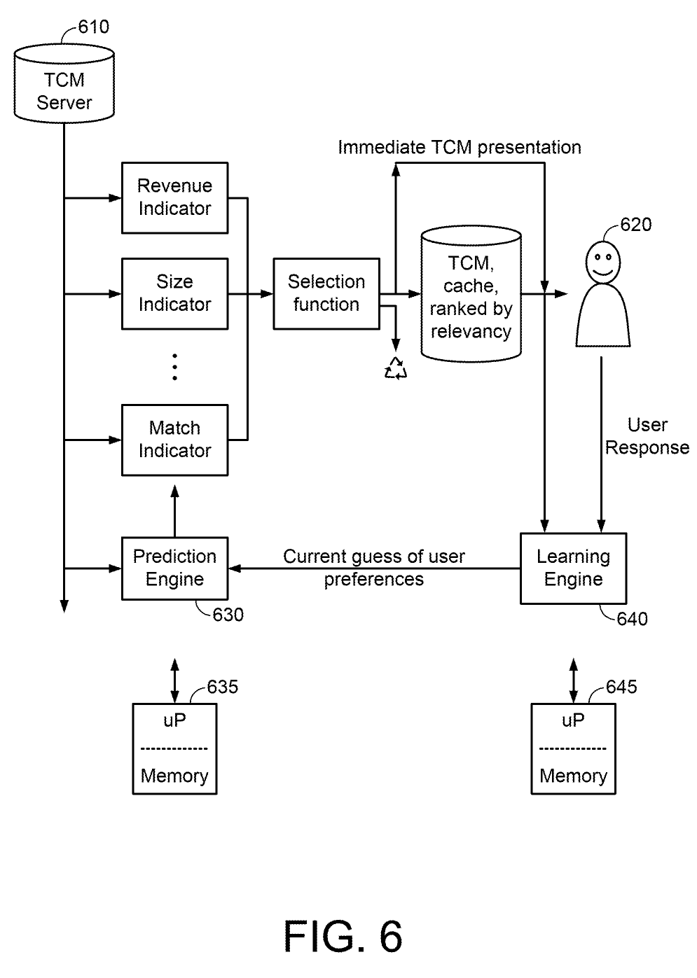

An example implementation paradigm is shown in FIG. 6, where the Targeted Content Message provider or Ad-server 610 may deliver a single TCM/message to a user's 620 mobile device in real-time such as a coffee TCM/message when the user is either walking past or driving past a coffee store. Based on the prediction model, it would be useful to take a decision on the mobile device on whether to present this TCM/message to the user based on match indicator value that is generated related to this information. Alternatively, a stream of meta-data information related to TCM/message may arrive at the mobile device, and the prediction algorithm could provide the relative values of the match indicators for each TCM/message, so that the mobile device could take a decision on which TCMs/messages to store in a space-constrained TCM/message cache on the device.

A selection function on the device may optionally use additional indictors such as associated revenue and size, in addition to the match indicator from the prediction engine 630 to take a decision on whether to present the TCM/advertisement/information to the user 620. Prediction engine 630 is shown with optional microprocessor and memory 635, which may be directly or indirectly coupled to the prediction engine 630. With regard to the learning engine 640, for information that is presented to the user 620, if there is a user response associated with the presented information, then both the meta-data associated with the user information and the user response can be used in the learning engine 640. Shown, optionally, with the learning engine 640 is microprocessor and memory 645, which may be directly or indirectly coupled to the leaning engine 640. In some implementations, the prediction engine microprocessor and memory 635 may be the same as the learning engine microprocessor and memory 645. In addition, in the information processing flow, the individual actions on a per-ad basis are not stored in the mobile device. The action along with the meta-data for a given TCM/information/ad are used to refine the user preference model and subsequently the inputs related to the user action and the information-meta-data can be discarded from the system.

User Profile as a Combination of Context Independence and Context Awareness

User preferences are generally contextual with respect to the activity that is being learned. For instance, a user may have different preferences with regard to TCMs/information that the user would like to see, and a different set of preferences with regard to web pages that the user would like to browse. For example, a user may read news on the web about crime in the local community news to be aware of such activity from a safety standpoint; however, that should not imply that the user would be interested in purchasing a gun through a TCM/message. Therefore a presentation engine on the platform would reflect different user preferences relative to the web browser preferences of the user. Other contexts could include user preferences related to a music application on the platform or a sports application on the platform. In general, learning and prediction engines could be required for every context.

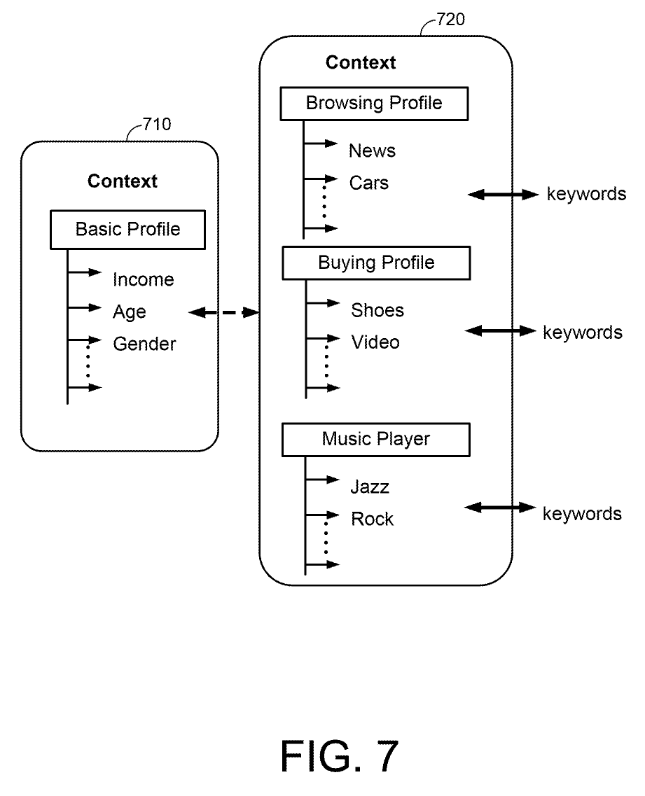

A possible scenario for determining the user profile is depicted in FIG. 7, composed of a context independent engine 720 and a context aware engine 710. It is noted that the keywords can be used to drive the context aware engine 710, and that information from the context aware engine 710 may be used to help drive the context independent engine 720. How these engines are used can be chosen as per the application and local demographics, if so desired. An introduction to possible methods for the learning and prediction engines are presented.

Learning and Prediction Engines

Using keywords as an input metric, let there be n keywords, each corresponding to a preference one may want to capture with regard to a user. Then a user's preferences can be abstractly represented as a vector P=(p₁, . . . , pₙ), where the value pᵢ corresponds to the user's preference level for the category i. Similarly, an advertisement or content or TCM based on its relevance to the keywords can be abstractly represented as a vector A=(a₁, . . . , aₙ), where the value aᵢ corresponds to how relevant the ad/content/TCM is to the keyword i. For this instance, it is assumed that ad/content/TCM are presented sequentially to the learning algorithm. It should be noted that typically there will be a large number (possibly several hundreds) of keywords, though most of them would be irrelevant to a particular ad/content or content. Similarly it is expected that the user will have strong preference on only a few keywords. Mathematically such vectors are called sparse. It is also presumed that the input training ad keyword vectors are sparse, and that the desired user preference vector P is also sparse. The current estimated guess of the user's preferences based on the user model is represented as \hat{P}.

Context-Aware Learning Engine:

4. Input: Content (represented as a vector): A
User response: ‘click occurred’

5. Persistent: Current guess of user preferences (as a vector): \hat{P} (initially 0). Decay parameter: D. Counter: C (initialized, for example, 0)

$$6. t := \{ \begin{matrix}1 / C & if C \leq D \\ 1 / D & o . w .\end{matrix} \\ 7. \hat{P} := ( 1 - t ) \hat{P} + tA \\ 8. C := C + 1$$

Prediction Engine:

1. Input: Content (represented as a vector): A

Current guess of user preferences (as a vector): \hat{P}

2. Return: \hat{P}·A

From the above algorithms, the following results are found:

If the TCMs/content and user preferences are sparse, then the learning engine can quickly learn the user preferences from the clicking behavior. The rate of learning is proportional to the sparsity.

The learning engine is robust to high noise. That is, even if user clicks on a large number of irrelevant TCMs, as long as she is clicking on a small percentage of relevant TCMs, the underlying preferences are learned.

If the underlying user preferences change, then the learning engine can adapt to the new preferences well.

Note that even though it is suggested to start the estimate \hat{P} at 0, in the presence of available information, a different starting seed can be used. For instance, knowing the local demographics can help to seed the profile of a new mobile user. Seeding the preferences to that of a typical (average) mobile user in an area would typically converge faster to the true underlying preferences of the user. Incorporating this is easy, initial value of \hat{P} would be set to the seed and steps 6, 7, 8 above change to:

\hat{P}:=(1−1/D)\hat{P}+A/D 6′.

Context Independent Profile

A context-independent (CI) profile is now explored, where the user's CI profile can be represented as a flat collection of attributes (this can include, but is not limited to, geographic, behavioral, psychographic, demographic information, and so forth). The mobile device would maintain a distribution over the possible values a particular attribute may take. This distribution reflects a measure of confidence on the value attained by the attribute. For example, it may be desirable to model the gender of the mobile user. The attribute ‘gender’ can take two values—‘Male’ or ‘Female’. Hence, the mobile device will maintain a distribution over Male/Female as, say, 0.8/0.2 which reflects the current confidence on user's gender being male as 80% and being female as 20%. Note that attributes can take either discrete or continuous values. For maintaining a compact representation of the distribution on the mobile device, grouping certain values in a single category bin in an appropriate manner can be used. For instance, in the following example, category ‘Age’ may be binned into categories such as: ‘below 13’/‘14-17’/‘18-21’/‘22-30’/‘30-40’/‘41+’.

This approach is effective for probabilistic reasoning and inference. Consider a targeted advertisement for teens; an ad provider may request that if we have, say, 80% confidence that the mobile user is in the age range of 13 to 19, the device should display the ad. The exemplary representation can effectively provide a usable solution to such requests. The CI profile can be derived in part based on usage of information by the user across multiple contexts. The context can be at least one of music, traffic, purchasing, dining, traveling, browsing, news, weather, sports, entertainment, and so forth, for example. Accordingly, other contexts may be implemented according to design preference.

Learning the Values for Different Context Independent Attributes

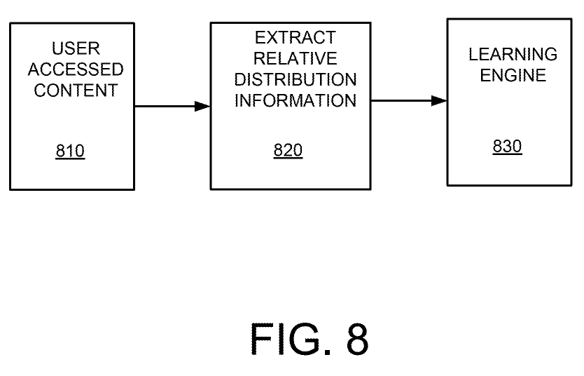

FIG. 8 is a block diagram illustration a possible learning engine input approach. The confidence on the value attained by a particular attribute can be updated by incorporating user interactions with the mobile device via a User Accessed 810->Extract Relative 820->Learning Engine 830 flow approach. For example, each object that the user accesses can be tagged with a relative distribution vector information regarding the category in the content meta-data. Note that if such information is not tagged, it may be inferred based on the content.

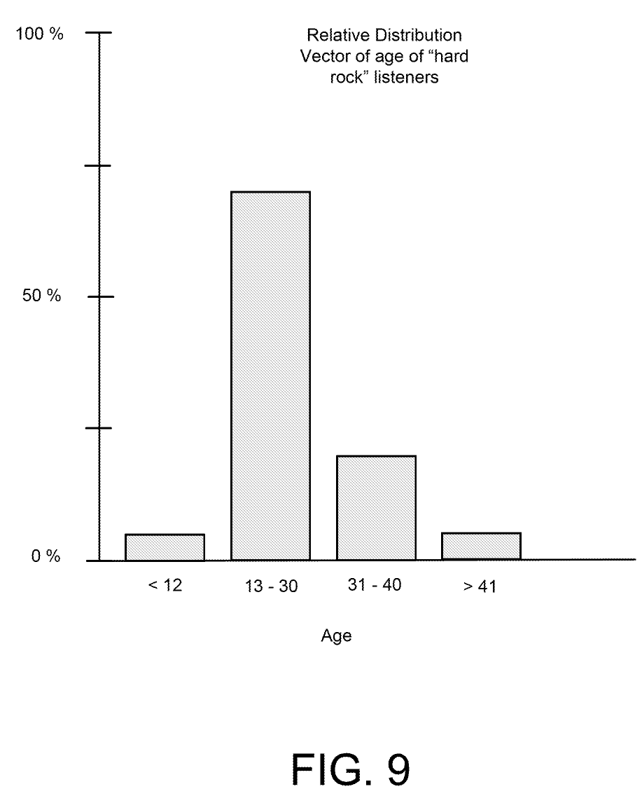

The relative distribution vector can provide relative weights for the different values that an attribute may take. When representing the attribute values as category bins, weights can be specified for each category bin. More precisely, suppose a particular mobile user accesses the content ‘hard rock music.’ Say, for instance, the aggregate statistics are as follows: 70% of males and 30% females listen to ‘hard rock music.’ The same content can also be tagged with additional statistical information, as say, 5% of people ages 12 below, 70% of people age 13-30, 20% of people age 31-40, and 5% of people age 40 above listen to this content. FIG. 9 provides a graphical illustration of a relative distribution vector [0.05 0.70 0.20 0.05] showing different “bin” percentages for the different age groups.

Abstractly, let i represent categories, for example, and j represent different “buckets”, then there be n attributes K₁, . . . , Kₙ, each corresponding a context independent category (such as age, gender, etc.). Each Kᵢ can take mᵢ values (age can takes values, for example, 0-13, 14-17, etc; gender takes values male, female). Thus, Kᵢⱼ represents the probability that attribute i takes value j. Note that ΣⱼKᵢⱼ=1 for all i.

As discussed above, each content can be tagged with relative distribution vector S₁, . . . , Sₙ, where corresponds to fraction of population whose attribute i takes value j accesses this information. As this information may not be very accurate, a confidence parameter cᵢ for each of these vectors Sᵢ, that reflects the confidence in the gathered information, can be introduced. Along with the distribution vector, the content may also be tagged with its accessed context (Web Browsing/Music Player/etc). For this example, it is assumed that there are m different contexts. Then the learning engine can be partitioned as follows:

Context Independent Learning Engine (per content access):

Input: Relative distribution vectors (Sᵢ represented as a vector): S₁, . . . , Sₙ

Confidence on the distribution vectors: c₁, . . . , cₙ

Context of the content access: x (taking value between 1 and m, for example)

Persistent: Current guess of the attribute categories (Kᵢ is a vector): K₁, . . . , Kₙ

Per context guess (Tᵢⱼ is a vector): T₁₁, . . . , T₁ₙ,

T₂₁, . . . , T₂ₙ, . . .

Tₘ₁, . . . , Tₘₙ

Counter: t₁₁, . . . , tₘₙ (initially all 0 or at some initial value)

Then, for each attribute i (from 1 to n, for example)

Tₓᵢ:=(tₓᵢTₓᵢ+cᵢSᵢ)/(tₓᵢ+cᵢ) a.

tₓᵢ:=tₓᵢ+cᵢ b.

Kᵢ:=ΣₓtₓᵢTₓᵢ/Σₓtₓᵢ c.

Note that the final update rule (expressed in item c) is a weighted combination current contextual guess for the attributes. This can also be combined in other ways when more information is known. It can be combined, for instance, as Kᵢ:=ΠₓtₓᵢTₓᵢ (with appropriate normalizations) when Tᵢ's are known to be independent.

The learning engine can adapt and update the relative distribution vectors (RDVs) for each of the attributes based on the input RDVs that are tagged with the content. As more content arrives with additional tagged information, the RDVs can be continuously refined, if so desired. In some aspects, an averaging of the RDVs may be implemented. Therefore, various forms of weighting or scaling may be utilized as needed.

The algorithm described above can be used to determine RDVs for attributes directly across contexts, so that any input tagged content from any context that the user responds to, can be used to refine the estimate of the RDV. Alternatively, the algorithm may be used to estimate an RDV for an attribute in a given context. In that case, it may be desirable, to compute an equivalent RDV across contexts. A hierarchical architecture to compute the RDV can be used to accommodate this capability.

Hierarchical Computation of the RDV

When an RDV is available for an attribute on a per context basis, then one may extract an equivalent RDV for the attribute by a weighted summation of the RDVs per context. The weights for each context could be chosen based on the relative frequency of usage of the contexts on the device. Alternatively, the weights may be specified by other means. In addition to RDVs being computed using the above algorithm, RDVs for an attribute may be available from other input sources, such as a Bayesian estimation or other means. All such estimates of RDVs can be hierarchically combined (along with RDVs obtained based on the suggested algorithm in the previous section) using various combining techniques (including but not limited to additive or multiplicative) across the individual estimates.

Content Matching Engine (Per Content)

Once the CI profile of the mobile user is learned, it can be used to measure the relevancy of information arriving at the mobile device to the mobile user. For instance, TCMs may be tagged with meta-data that if we are 80% confident that the user is a female, and 70% confident that the user is over the age of 40, then display the ad to the user.

This can be done very efficiently with the exemplary models, as further described below.

1. Input: Desired attribute relevancy Vectors (Rᵢ represented as a vector): R₁, . . . , Rₙ Relative weights associated with the vectors: w₁, . . . , wₙ

2. Persistent: Current guess of the attribute categories (Kᵢ is a vector): K₁ . . . , Kₙ

3. return ΣᵢwᵢΣⱼ(Kᵢⱼ−Rᵢⱼ)

If the absolute decision is required, the returned value can be thresholded at 0 or equivalently compute the signum function of the returned value, where

signum (x)=1 . . . x>0
−1 . . . x<0
0 . . . x=0.

The return value (Step 3. above) provides a relevancy measure based on the tagged RDVs of the new content and/or information, relative to the learned RDVs for the user. Given the resources available, the tagged RDV may include statistical information gathered from a population of users, which may include information from a survey, user feedback, user behavior, and so forth. Continuing, an overall suitability measure for presentation or displaying content in the information to the user (for example, on the user's device) can be determined based on the determined relevance metric and zero or more additional metrics. The additional metrics can be at least one of a keyword correlation metric, for example, the return value from the prediction engine for keyword correlation—e.g., \hat{P}·A, or an energy consumption metric, processing requirement metric, monetary value of the information metric, size of the information metric, duration of information transmission metric, channel quality metric, and so forth. An example of one metric may be with respect to battery consumption concerns which can be input as a measure in determining if a static image or video should be received. Of course, other metrics may be utilized according to design or need. Additionally, the determined relevance metric may be stored, either remotely or on the user's device, for a later displaying of the content of the information to the user. In some instances, instead of using a learned RDV for determining relevance, a random RDV may be used to determine relevance. Conversely, in some instances, a learned RDV may be utilized in determining relevance of information based on the convergence of the learned RDV. For example, how fast or how unstable convergence is for the learned RDV can be used as an indicator of relevance.

Entropy Approach

An entropy based predictive state model can be used based on a client platform. For example, a directed state transition graph can be created that includes the N most relevant contexts as nodes in the graph, with edges encoding probabilistic transitions between nodes. Let arbitrary nodes be numbered X₁, Xₗ, Xₖ, Xⱼ, . . . , X_{N}. Without loss of generality, consider the node X₁. One-state conditional entropies H(X₁|Xⱼ) are computed. Subsequently, two state conditional entropies are H(X₁|Xⱼ), Xₖ) are computed. Likewise, higher-state conditional entropies are computed. Prediction of a future context state at a given time, is based on past observations of most relevant context states within a given time window or horizon. For example, let Z be the distribution associated with a sequence of some k most relevant states in the given time window. The mutual information I(X|Z)=H(X)−H(X|Z) is computed. Thus, the mutual information I(X|Z) is the reduction in the uncertainty of X due to the knowledge of Z. It is therefore beneficial to reduce the entropy in X as much as possible with the knowledge of Z. If an additional state is used with a distribution over (k+1) states, it may reduce the entropy in X further. However one needs to only use an optimal value of k where further reductions in entropy are marginal (for example, a convergence or substantial lack of additional change, etc.). Computational costs, energy costs, and storage costs can impact the choice of k as well.

RDVs can be used in the context of a predictive state model on the user platform where the user state can comprise at least one of a user's location, mobility, current time, and behavioral activity. The selection of content for presentation can be based on a user state and on a suitability measure of the content. Also, the predictive state model can select content based on a future predicted state, wherein the prediction of the future state can be based on a reduction of an uncertainty of the future state based on at least one or more known prior states. Also, the predictive state model can utilize the current state and zero or more number of prior states for the prediction of a future state, wherein the choice of the number depends on the amount of increase in the reduction of the uncertainty of the future state based on usage of the knowledge related to the prior states.

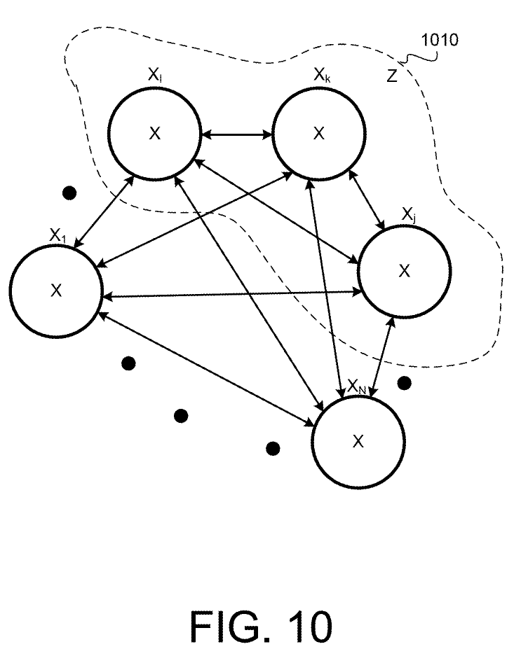

FIG. 10 illustrates an example of the above, using relationship vectors between arbitrary states numbered X₁, Xₗ, Xₖ, Xⱼ, . . . , X_{N}. Z 1010 represents the entropy distribution relationship for the set of Xₗ, Xₖ, and Xⱼ states. The entropy relationship between X₁ and the Xₗ, Xₖ, and Xⱼ states can be computed as H(X₁|(Xⱼ, Xₗ, Xₘ))=H(X₁)−I(X₁; (Xⱼ, Xₗ, Xₘ)). The value of H(X₁|(Xⱼ, Xₗ, Xₘ)) can be refined by increasing the number of states that are utilized, to a desired convergence. In some instances, the entropy of future events/information may be calculated as well as past and present events/information.

For example, at any given time, among all possible choices of a future most relevant context, the highest probable relevant state can be predicted as a future state, such that for each future context state, only an optimal number of k previous context states are used such that the entropy in the prediction of the future context state is minimized. It should be noted that for each most relevant node state the choice of k can be different (this choice is based on the past observations of user behavior) after which refining the model for predicting Nᵢ has only marginal improvement in reducing the entropy in the prediction. That is, a termination of additional source level state history may be implemented if the additional source level state history is non-beneficial.

This approach provides the ability to analyze and learn dependencies between context states using a model for a future predicted context state that depends on a k previous context states, where the choice of k is variable per context state and is optimized per context state, such that there is only marginal reduction in the entropy regarding the prediction of the context future state.

The above approach can also be applied to developing/training RDVs, based on input data (including meta-data) to accurately evaluate the likeliness of the attribute (or range of attributes) sought with the user. Relevance metrics may be utilized as needed as well as the convergence behavior of the RDV(s). The RDVs can be an absolute measure or relative, independent across contexts, dependent across contexts, etc., depending on the approach utilized and the information provided. In some instances, the RDVs can be averaged over past, new and inferred responses, and so forth.

The developing/training of the RDVs can be equated to learning vectors and can come, for example, from information (a priori or later derived) from the advertiser. The developing/training of the learning vectors may also be jump started by having the user enter a starting profile. In some instances, this may simply be accomplished by the user answering initial questions concerning the user, or the provider downloading information from the provider's subscription database concerning the user. In other instances, the initial activities (or at some defined time/usage period) of the user on the mobile device may constitute a threshold of information for the developing/training process. Further, a random RDV or even selection of content can be utilized. Initializing procedures are well known in the art, therefore, alternative approaches are understood to be within the purview of this disclosure. For example, thresholds may be used as part of initialization.

In content matching, several approaches can be utilized for the developed/trained learning vectors. For example, only the learning vector can be used for that particular context in the context engine. Alternatively, a computed weighted average over the learning vectors across the contexts may be used. The weighting can be used to specify relative importance of each context for that particular user property (and/or bucket). Other approaches for content matching are well known in the community and therefore may be used, without departing from the spirit and scope herein.

Also, in some instances, a certain degree of randomness may be introduced to the learning or prediction engines, to refine the user's model by further exploring the user's interests. The randomness may operate to increase the robustness of the learning or prediction engines (bringing in previously unknown interests), and/or increase the usability and interest factor for the user. For example, random content may be displayed to the user irrespective of an RDV.

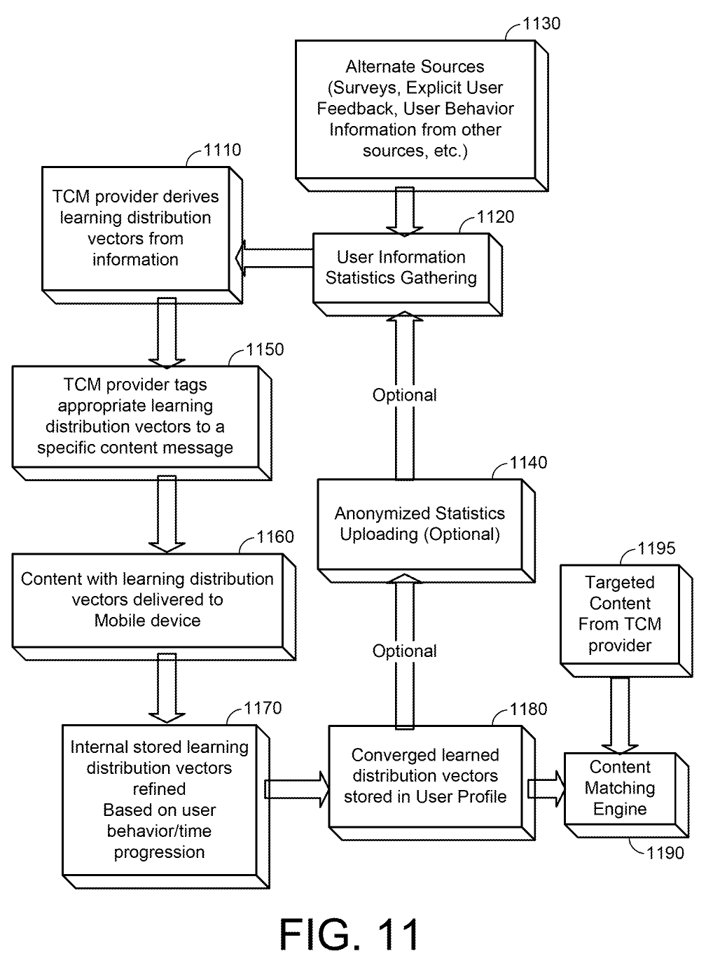

FIG. 11 provides a flow path example of several possible examples for implementing some of the techniques described above, in the context of learning distribution vectors (in some instances, referred to as relative distribution vectors). The flow path of FIG. 11 can start with the Targeted Content Message provider deriving module 1110 which derives learning distribution vectors according to the descriptions described above from known information. This information can be obtained from User information module 1120 which gathers statistics from various sources. User information module 1120 may acquire or gather all or some of its information from Alternative Sources module 1130 and optionally Anonymized statistics module 1040, as well as other available sources, as needed.

From TCM provider deriving module 1110, the flow of information proceeds to TCM tagging module 1150, which tags appropriate learning distribution vectors to specific content message(s). Next, Content distribution module 1160 delivers the content with learning distribution vectors to the mobile device(s). The flow proceeds to Refining module 1170 that refines the distribution learning vectors stored in the mobile device based on user behavior which may include various attributes such as location, age, and so forth.

Next, User profile module 1180 acquires converged learned distribution vectors and forwards to Content matching engine module 1190 and (optionally) to Anonymized statistics module 1140. The Content matching engine module 1090 also is recipient to content from Targeted Content module 1195, from the TCM provider/advertiser(s) and functions in part as a filtering module to determine content that is apropos to the user.

Accordingly, a feedback mechanism with various sources and levels of “processed” information can be devised for determining what information is to be disseminated to the user. Using the various systems and methods described herein, as applicable to the various modules of FIG. 11, a more accurate or relevant set of information can be forwarded to the user as well as information that is context independent/dependent and also predictive in nature, if so desired. It should be appreciated that the forwarded information can be the learned RDVs and can be stored, for example, in the a user profile on the client device. Therefore, a heightened level of privacy can be afforded to the user while still allowing effective delivery of information.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields for example. Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an access terminal. In the alternative, the processor and the storage medium may reside as discrete components in the access terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for determining relevance of information from an information source to be displayed to a client device, comprising:
utilizing at least one or more tagged relative distribution vectors (RDVs) for the information; and
learning at least one or more RDVs of a user of the client device based on a user's response to a content of the information.

2. The method of claim 1, wherein at least one of the tagged RDVs and the content of the information is delivered dynamically to the client device.

3. The method of claim 1, further comprising storing the learned RDVs in a user profile on the client device.

4. The method of claim 1, further comprising matching received information from the information source based on at least one learned RDV in a user profile to determine a suitability of the content of the information for display.

5. The method of claim 4, wherein an overall suitability measure for presentation of content in the information to the user is determined based on a determined relevance metric and zero or more additional metrics, the additional metrics being at least one of a keyword correlation metric, energy consumption metric, processing requirement metric, monetary value of the information metric, size of the information metric, duration of information transmission metric, or channel quality metric.

6. The method of claim 1, further comprising determining to utilize a learned RDV for determining relevance of information based on a convergence of the learned RDV.

7. The method of claim 1, further comprising utilizing one or more learned RDVs for determining a relevance metric for the information wherein the determined relevance metric can be used to discriminate against multiple other information to determine to at least one of a most relevant or sorted information.

8. The method of claim 1, wherein a random RDV is used for determining a relevance metric for the information or random content is displayed.

9. The method of claim 1, wherein at least one RDV is for a user attribute containing at least one of age, income, gender, and health.

10. The method of claim 1, further comprising forwarding at least one or more stored learned RDVs to an anonymizer module for anonymization.

11. The method of claim 1, wherein at least one RDV is independent across a context of usage of information by the user or at least one RDV is determined based on usage of information by the user within a context, wherein the context is at least one of music, traffic, purchasing, dining, traveling, browsing, news, weather, sports, or entertainment.

12. The method of claim 1, further comprising determining at least one of a future user spatial, temporal and behavioral action based on a predictive user state model, wherein a user state comprises at least one of a user's location, mobility, current time, or behavioral activity.

13. The of claim 14, wherein the predictive user state model selects content based on a future predicted state, wherein the prediction of the future state is based on a reduction of an uncertainty of the future state based on at least one or more known prior states.

14. An apparatus for determining relevance of information from an information source to be displayed to a client device, comprising:
a processor (, 645) linked to the memory and configure to control operations for:
utilizing at least one or more tagged relative distribution vectors (RDVs) for the information;
learning at least one or more RDVs of a user of the client device based on a user's response to a content of the information; and
a memory coupled to the processor for storing data.

15. A computer program product comprising:
a computer-readable medium comprising:
code for utilizing at least one or more tagged relative distribution vectors (RDVs) for the information; and
code for learning at least one or more RDVs of a user of the client device based on a user's response to a content of the information.
